(19) United States
(12) Patent Application Publication
(10) Pub. No.: US 2024/0318696 A1
(43) Pub. Date: Sep. 26, 2024

(54) Disc Brake and Brake Pad for a Disc Brake

(71) Applicant: KNORR-BREMSE Systeme fuer Nutzfahrzeuge GmbH, Muenchen (DE)

(72) Inventors: Ralf WEBER, Muenchen (DE); Abdelaziz RGUICHI, Olching (DE); Andreas BUCH, Taufkirchen (DE); Alexander WERTH, Muenchen (DE); Rudolf FISCHER, Erding (DE); Zoltan RIBA, Olching (DE); Erkan AKBALIK, Muenchen (DE)

(21) Appl. No.: 18/698,891

(22) PCT Filed: Sep. 28, 2022
(86) PCT No.: PCT/EP2022/076893

§ 371 Date: Apr. 5, 2024

(30) Foreign Application Priority Data
Oct. 7, 2021 (DE) 10 2021 126 026.4

(51) Int. Cl. F16D 65/00; F16D 65/092

(52) U.S. Cl. CPC F16D 65/0031; F16D 65/0068; F16D 65/092

(57) ABSTRACT

A disc brake has a brake caliper which engages over a brake disc and in which brake pads each provided with a friction lining and with a back plate are arranged that can each be pressed with their friction lining on both sides onto friction ring surfaces of the brake disc. A suction tube arrangement is provided through which abrasion material resulting from braking is sucked, wherein the suction tube arrangement includes one or more suction tubes arranged directly on the two brake pads. A corresponding brake pad set is also provided.

### BACKGROUND AND SUMMARY

The invention relates to a disc brake having a brake caliper which engages over a brake disc in use, and two brake pads arranged in the caliper, which are each provided with a friction lining and a back plate.

The applicable environmental requirements and the associated legal bases will in the future bring with them increased requirements for the avoidance of particulate matter. It will therefore be necessary to develop technical solutions for disc brakes for commercial vehicles that are able to minimize brake dust, in particular the fine dust content of brake dust, and ideally prevent its emission.

The technical solutions available for this purpose, which primarily focus on the passenger car sector, are largely designed to guide and collect the brake dust from the installation space surrounding the disc brake through a filter, with or without the aid of air pressure, preferably with a suction and separation system. For this purpose, it is usually necessary to limit the surrounding installation space by installing cover or shielding plates around the wheel brake (see e.g. US 2010/0096226 A1).

WO 2008/083884 A1 discloses the use of such a suction and separation system, which has a fine dust filter on one side of the brake disc of a disc brake and a fan on the other side, both of which are positioned in a wheel rim, with the fine dust filter being held on the rim in a hermetically sealed manner with respect to the surroundings.

EP 2 585 730 B1 discloses a generic disc brake with a suction and separation system that is also suitable for use on commercial vehicles. The disc brake has a brake caliper which overlaps a brake disc and in which brake pads provided with friction linings are arranged, each of which can be pressed with its friction lining on both sides against friction ring surfaces of the brake disc, wherein the friction rings are covered outside the overlapping area of the friction linings by a housing which is fixed relative to the brake caliper and which is connected to a suction device, wherein a dust extraction device is provided between the housing and the suction device.

This design has proven itself well, but should be further optimized. For example, the vehicle's surroundings, primarily the conditions in the wheel housing and inside the rim, can cause diffuse turbulence of the resulting brake dust due to the airstream. Similarly, the cover plates can hardly be designed in such a way that the brake is completely encapsulated. This is because further encapsulation of the brake could result in corresponding thermal problems with the friction pairing.

The invention is based on the object of further developing a disc brake of the generic type in such a way that the escape of brake wear into the environment is largely prevented by simple design means. The invention also has the object of creating a brake pad set consisting of two brake pads which is particularly suitable for such a disc brake.

This object is solved by a disc brake and by a brake pad set in accordance with the independent claims. Advantageous embodiments and further developments are given in the dependent claims.

The invention first creates a disc brake, having a brake caliper which engages over a brake disc and in which brake pads are arranged which are each provided with a friction lining and a back plate and which can each be pressed with their friction lining on both sides onto friction ring surfaces of the brake disc, and having a suction tube arrangement for extracting abrasion material resulting from braking, wherein one or more suction tubes of the suction tube arrangement is/are arranged on each of the two brake pads.

A brake pad set is also provided, in particular for a disc brake, having two brake pads, each of which has a friction lining and a back plate, in each of which one or more suction tubes of a suction tube arrangement arranged directly on the two brake pads are provided.

In this way, a very high proportion of the abrasion material caused by braking is safely absorbed.

The following further developments relate in each case to features that can be realized on the pad set and which, however, also lead to further development of the disc brake independently of this when the pad set is installed on the disc brake.

According to a first further development, it is provided that the respective brake pad and the suction tube(s) arranged on it form a pre-assembled, replaceable unit of the disc brake. In this way, elements of the suction tube arrangement are also replaced when the pad is changed, so that the function of the suction system remains ensured even in older vehicles. In addition, pad replacement is made easier, as it is not necessary to fit the tubular elements provided for the suction system when replacing the pads, as the brake pad and these tubular elements are provided as a pre-assembled unit. Replacing the pads and the suction device is particularly easy if the suction tube arrangement as a whole or essentially (e.g. except for interface element(s)) and the two brake pads as a whole form a pre-assembled, replaceable unit of the disc brake.

In order to safely extract a high proportion of the abrasion material virtually at the point where it occurs, according to another further development it is provided that the suction tubes arranged on the two brake pads each have one or more suction openings and that they are placed in sections or completely circumferentially around the friction linings. This design practically encapsulates the friction surfaces of the brake pads. The extraction efficiency is further optimized.

It is also structurally simple and advantageous in terms of extraction efficiency if the respective suction tube with suction openings forms a circumferentially closed ring, the ends of which are attached to or formed onto a Y-tube section.

According to another further development, it may be provided that the respective suction tube with suction openings is movably guided on the respective brake pad. This makes it possible to move the suction tube as the lining wears in accordance with the decrease in the thickness of the friction material.

According to a further embodiment, this can be particularly advantageous if the respective suction tube with suction openings is movably guided on the respective brake pad by means of at least one spring, in particular at least one disc spring. In this way, it can be achieved that the respective suction tube terminates with the wear surface of the respective brake pad and rests against the brake disc when the brake pads are pressed on.

For this purpose, it can also be advantageously provided according to a variant that a positive fit between a respective guide pin and a disc spring is designed in such a way that the guide pins can be displaced in their axial direction by the disc springs, by means of the contact pressure of the brake pads, unidirectionally in the direction of wear and plane-parallel to the wear surface of the brake pads. If the bushing is of unidirectional design, the suction device releases the clearance again when the brake is released and there is no residual grinding torque.

In another optional further development, it is provided that the respective suction tube, which is guided around the lining material on the two brake pads, is covered and/or sheathed on the respective brake pad in whole or in sections by means of a wiper. In this way, noise can be minimized by simple means. In addition, the efficiency of collecting abrasion material can be further improved in this way.

According to another further development, which can also be regarded as an independent invention, it is provided that the suction tube arrangement has at least one interface for connecting a suction and separation device external to the disc brake. This at least one interface can be designed in a wide variety of ways. For example, it can be designed as a tube coupling element, to which another coupling element can then be easily connected to the suction and separation device. However, the interface can also be designed as a tube end to which a tube end of the section and separation device can be attached with a clamp.

According to an advantageous further development, it may be provided that the at least one interface has at least one variable-length element, in particular a variable-length bellows or a grommet. In this way, movements of the suction tube arrangements, e.g. caused by disc and/or lining wear and/or clamping movements and/or shaking at the interface, can be easily compensated and absorbed.

The suction and separation device downstream of the disc brake can have one or more separation devices, for example a coarse dust separator arranged initially in the direction of the housing, through which the polluted, extracted air is guided to a fine dust filter, which is connected upstream of the suction device, preferably a suction blower, while a silencer can be provided downstream of the suction blower, through which the air cleaned in this respect is guided into the open air.

The suction device is conveniently switched via a switching unit coupled to the braking device, which is controlled in such a way that the suction device remains in operation for a certain time after braking has ended. When the brakes are not applied and the vehicle is moving freely and after the specified stopping time, suction is not necessary. This means that effective filtration can be achieved with relatively low extraction air volumes, which is characterized above all by low operating costs.

Further advantageous embodiments of the invention are characterized in the dependent claims.

An exemplary embodiment of the invention is described below with reference to the accompanying drawings. Features of this exemplary embodiment can also be used individually or jointly in other exemplary embodiments of the invention not shown. The invention is not limited to this exemplary embodiment, but can also be implemented within the scope of the claims in other ways than shown and in particular also equivalently.

### BRIEF DESCRIPTION OF THE DRAWINGS

FIG. 1 shows a front perspective view of a disc brake according to an embodiment of the invention;

FIG. 2 shows a part of the disc brake in a perspective rear view;

FIG. 3 shows a perspective view of a brake pad set of a disc brake, for example as shown in FIGS. 1 and 2, having two pads and a suction tube arrangement;

FIG. 4 shows the elements from FIG. 3 in an exploded view;

FIGS. 5a and 5b show different views of an interface element of the suction tube arrangement;

FIG. 6 shows a side view of a section of the pad set from FIG. 3 with elements of the suction tube arrangement;

FIG. 7 shows a sectional view of the pad set from FIG. 3 with elements of the suction tube arrangement;

FIG. 8 shows a detailed view A of the sectional view from FIG. 7;

FIG. 9 shows a top view of the disc brake of FIGS. 1 and 2 and at the same time a sectional view through a bellows/Y-connection interface;

FIGS. 10-12 show various views of individual components of the suction tube arrangement; and

FIGS. 13-14 show further brake pad sets.

### DETAILED DESCRIPTION OF THE DRAWINGS

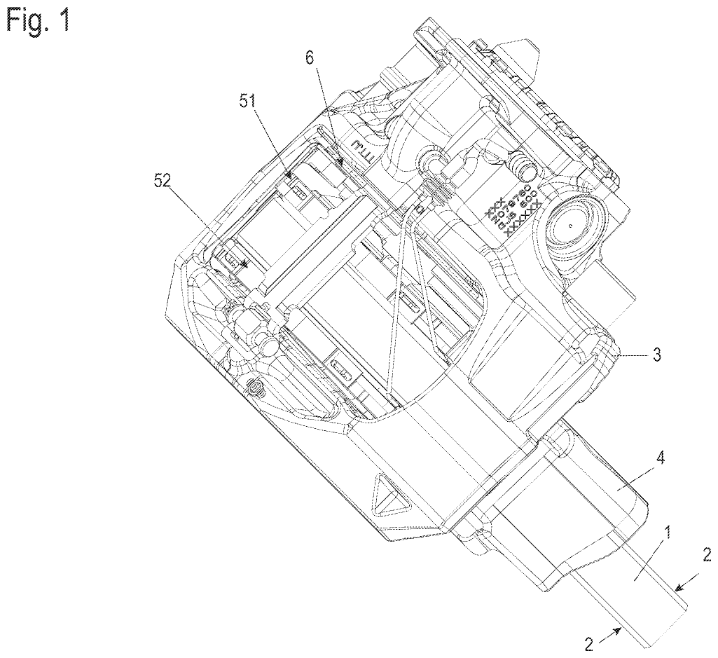

FIG. 1 shows a disc brake with a brake caliper 3, in this case a frame-like brake caliper, engaging over a brake disc 1. This brake caliper 3 is movably, in particular displaceably, arranged on a brake carrier 4, which can be attached to one side of a vehicle axle (not shown here). The brake carrier 4 is optional. Within the scope of the invention, the brake caliper 3 can be designed, for example, as a pivoting caliper, sliding caliper or fixed caliper (without brake carrier).

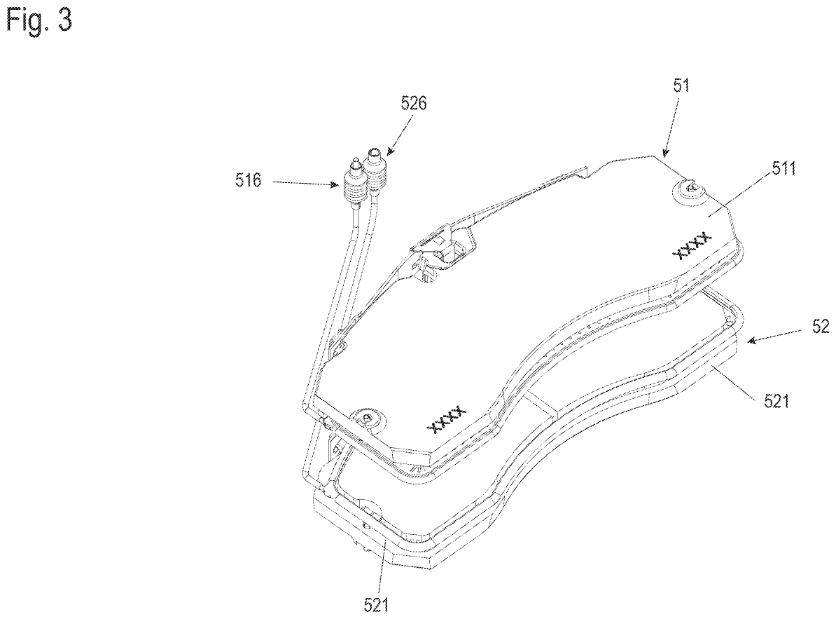

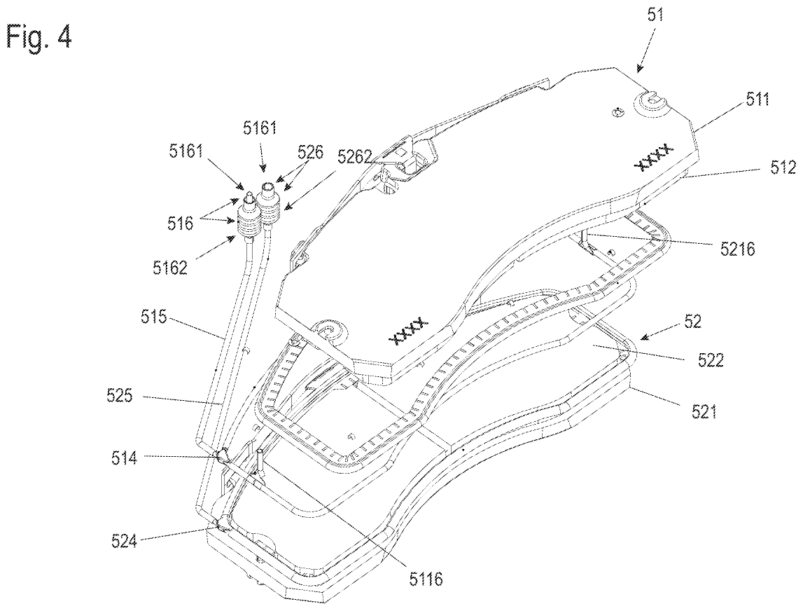

Brake pads 51, 52 are arranged in the brake caliper 3 and optionally in the brake carrier 4 on both sides of the brake disc 1. These brake pads each have a back plate 511, 521 and a friction lining 512, 522 (FIGS. 3, 4).

The brake caliper 3 here has a central opening 6 above the brake disc 1, through which the brake pads 51, 52 can be fitted and removed, in particular in order to replace them when changing the pads.

During braking, the brake pads 51, 52 can each be pressed with their friction lining 512, 522 on both sides against friction ring surfaces 2 (FIG. 1) of the preferably internally ventilated brake disc 1. An actuator (not shown here) is assigned to the disc brake for this purpose. This can be an electric motor or a pneumatic or hydraulic actuator and/or a spring actuator. This actuator can act on one or both brake pads 51, 52 via a clamping mechanism—here inside the brake caliper 3—in order to press them against the brake disc 1. In the case of a sliding caliper brake, for example, one of the two brake pads 51, 52 is pressed against the brake disc 1, while the other of the two brake pads 51, 52 is pulled with the brake caliper 3 against the other side of the brake disc 1. The clamping mechanism also includes an adjustment device for setting the clearance, which changes as a result of lining and disc wear during operation.

During braking, the clearance between the brake pads 51, 52 and the brake disc 1 is overcome. As a result of the resulting friction, abrasion occurs on the friction linings 512, 522 and also on the brake disc 1 during braking.

According to the invention, this abrasion is extracted directly from the brake pads 51, 52 in the area of the contact surface of the respective friction lining 512, 522 on the brake disc 1. In this way, this disc brake also meets the highest environmental protection requirements with regard to abrasion.

In addition, at least one suction and separation system is provided on the vehicle equipped with the disc brake (not shown here), which may have a suction fan or the like, not shown here, with which the abrasion is fed to a dedusting device. This can have one or more separation and/or filter stages. The abrasion-free air that emerges can, for example, be discharged into the environment via a silencer downstream of the suction fan. The abrasion is collected and disposed of separately.

The suction and separation system outside the disc brake on the vehicle can be designed or used for one or more of the disc brakes of the vehicle. By way of example, reference is made to EP 2 585 730 B1, which discloses components of such a system.

The abrasion material is collected directly at the point of origin, i.e. at the individual disc brake, by means of an exchangeable suction tube arrangement integrated into the disc brake, which is designed to collect the abrasion material directly at the contact surface between the brake disc 1 and the respective friction lining 512, 522.

Part of this suction tube arrangement can be particularly advantageously integrated directly into the two brake pads 51, 52. It is also possible for the two brake pads 51, 52 to form a pre-assembled unit with the suction tube arrangement, which is largely or even completely replaced with the brake pads 51, 52 when the brake pads are replaced.

It is also contemplated that the individual brake pads 51, 52 each form a pre-assembled brake pad unit together with their piping, wherein these two pre-assembled brake pads are then initially fitted during a change, whereupon further elements of the suction tube arrangement are fitted. This also enables an advantageous pad change.

It may be provided (see FIGS. 3 and 4) that each of the brake pads 51, 52 has a suction tube 513, 523 directly associated with the respective brake pad 51, 52, in particular integrated therein. The two suction tubes 513, 523 of the suction tube arrangement of the two brake pads 51, 52 can be brought together at one location of the disc brake. For example, they may terminate via a Y-piece 514 of the suction tube arrangement and one or more optional intermediate tubes 515, 525 in or likewise in a respective or common first interface 516, 526 of the suction tube arrangement. This first interface 516, 526 can serve to connect corresponding elements of the again preferably external suction and separation system or to connect an intermediate piece, which is hereinafter referred to as the second interface 7.

As the suction tube arrangement is also replaced when the pad is changed, this suction of the abrasion material is ensured in a particularly advantageous way by using new or cleaned elements after the pad has been changed.

Preferably, the respective suction tube 513, 523 is designed in such a way that it surrounds the respective friction lining 512, 522 of the respective brake pad 51, 52 completely or in sections in a frame-like manner.

The back plate 511, 512 of the respective brake pad 51, 52 can each be larger on its side facing the friction lining 512, 522 than the friction lining 512, 522, so that a circumferential back plate edge region 5221 surrounds the friction lining 512, 522. The respective suction tube 513, 523 can, for example, advantageously be formed on the edge region, in particular on an edge region 5121 of the respective back plate 511, 521 that completely surrounds the respective friction lining. In the edge region 5121, a groove can also be formed that extends completely or partially around it, or a shoulder can be formed into which the suction tube engages, at least with increasing wear (not shown here).

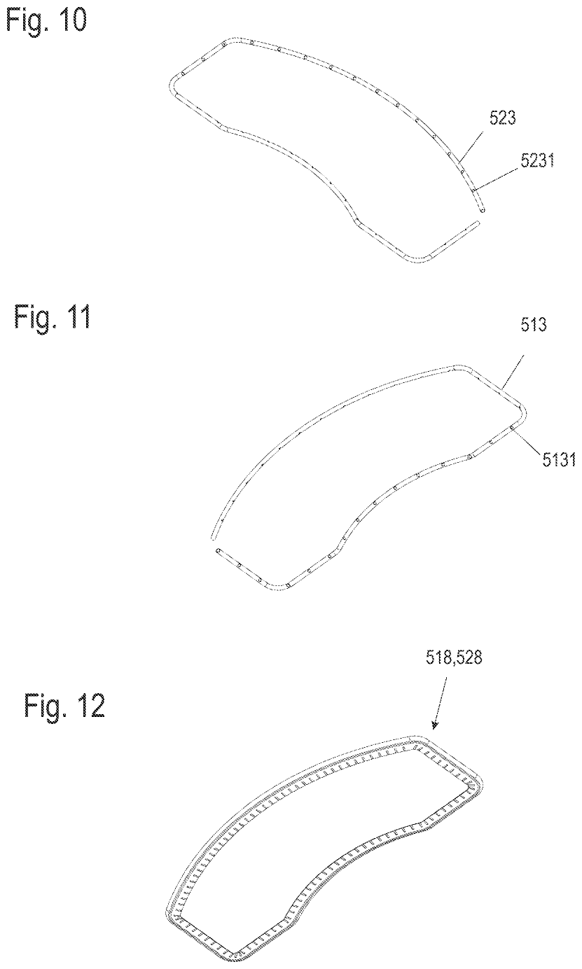

The respective suction tube 513, 523 can have suction openings 5131, 5231, for example several openings spaced apart from one another, which serve as suction openings. These suction openings 5131, 5231 can face the brake disc 1 (see FIGS. 10 and 11).

The respective suction tube 513, 523 can follow the contour of the circumferential edge around the friction lining 512, 522. It can be provided with the suction openings 5131, 5231 such as slots or small holes.

The respective suction tube 513, 523 thus preferably extends around the respective friction lining. The two ends of the circumferential suction tubes 513, 523 can then end in the Y- or T-piece 514, 524. In this way, a suction ring is formed. The tube sections 515, 525 can then lead from the respective first Y-piece 514, 524 to the respective first interface element 516, 526. In this way, the brake dust can be extracted and collected directly at the point of origin.

The respective suction tube 513, 523 can be arranged movably on the respective brake pad 51, 52. Thus, it may be provided that the suction tubes 513, 523 are each arranged movably on the respective brake pad 51, 52 by means of one or more springs. It may be provided that the respective suction tube 513, 523—against the force of the one or more springs—is movable perpendicular to the friction surface of the respective brake pad 51, 52. In this way, the respective suction tube 513, 523 can be moved all the way to or close to the friction surface of the respective friction pad 512, 522 facing the brake disc 1 and the respective friction ring surface 2 and, with increasing lining wear, can move back in the direction of the back plate 511, 521 without being destroyed itself.

In order to ensure that the suction tube 513, 523 is always in direct or almost direct contact with the contact surface of the friction pairing, but no longer rubs against the brake disc when the brake is released, it is preferably provided—as already briefly mentioned—according to a further development that it moves along with the wear surface of the brake pad 51, 52.

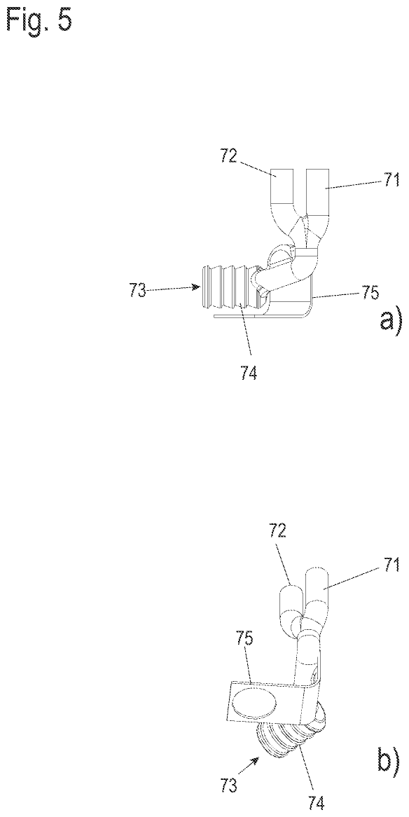

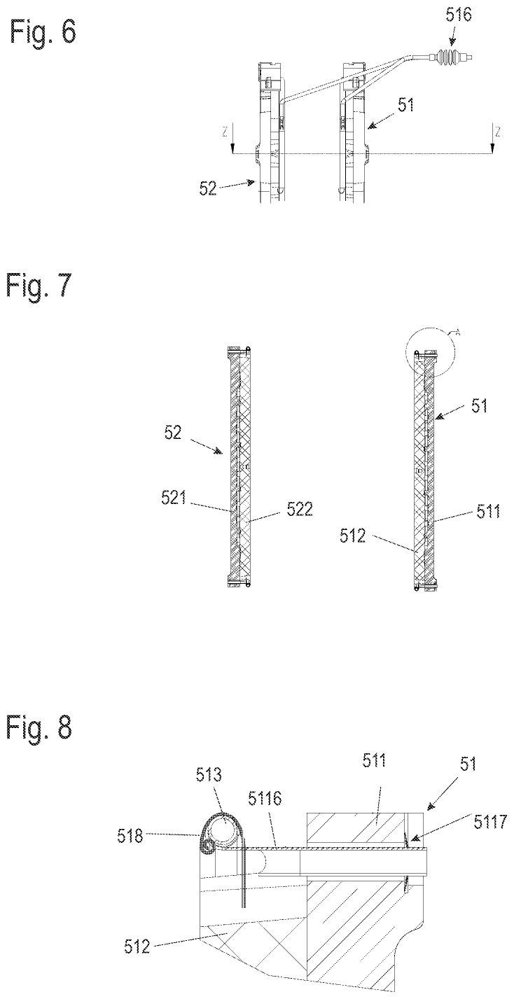

For this purpose, one or more guide pins 5116, 5216 (see also FIG. 4 and in particular FIGS. 5 and 6) can be attached to the suction tube 513, 523, which are mounted in disc springs 5117, 5217 so as to be displaceable on one side. The disc springs 5117, 5217 can be fixed in a pocket in the lining carrier plate of the respective brake pad 51, 52 in the axial direction of the guide pins 5116, 5216. Due to the geometry of the disc springs 5117, 5217, the unit can be pushed in the direction of wear of the brake pad 51, 52 upon contact with the brake disc.

In the opposite direction, the disc spring 5117, 5217 preferably clamps the guide pin 5116, 5216 by pressing the edge of the disc spring 5117, 5217 into the outer circumference of the guide pin 5116, 5216 by means of friction.

In order to achieve a better seal between the contact surface of the brake pad 51, 52 and the brake disc 2, the suction tubes can be completely or partially covered or even encased with a wiper 518, 528 (FIG. 8, FIG. 12).

If the suction power is correspondingly high, the wiper 518, 528 can also be replaced by spacers at certain points. In addition, the wiper 518, 528 may also optionally assume the functions of wear and damping of the surrounding suction tubes 513, 523.

Without the wiper 518, 528, the sliding contact would cause a high level of wear on the suction tubes 513, 523 during brake actuation. Likewise, the circulating suction tubes 513, 523 could be set into vibration and cause corresponding noise. The respective wiper 518, 528 can have a frame-like design (FIG. 12).

The respective wiper 518, 528 can be made of high-strength, temperature-resistant fabric. Depending on the fabric type, these can withstand temperatures of approx. >650° C. to <1200° C. For example, glass fiber, CFC, silicate and ceramic fabrics with a wide variety of reinforcements can be used for this task. For standard applications, a temperature resistance of up to 650° C. may be sufficient. The fabric can be sewn all the way around or attached to the suction tubes 513, 523 using clips.

The suction tubes 513, 523 preferably have suction openings 5131, 5231 which are arranged with the smallest possible gap to the contact surface of the brake pad 51, 52 to the brake disc 1. The position, shape and size of the suction openings 5131, 5231 are advantageously preferably designed such that the maximum suction effect is achieved at the point of greatest brake dust generation.

The tubular elements can be inserted without gaps using a press fit or welded on if necessary.

The respective first interface element 516, 526 can have a connection section 5161, 5261 and a variable-length unit with a bellows 5162, 5262. The respective first interface element 516, 526 can represent a first interface to a second interface element 7 to the suction and separation system.

It may be provided that this second interface element 7 forms part of the pre-assembled set of brake pads. However, it may also be provided that this second interface element 7 is not replaced when the lining is changed.

The second interface element 7 has a Y or T geometry with regard to the fluid conduction function. It therefore has two input connections 71, 72 for the two connection sections 5161, 5261 of the first interfaces and it has an output connection 73 to a corresponding connection of the suction and separation system. It can also have a grommet section 74. It can also have a fastening section 75, such as a perforated sheet metal tab. The second interface element can be attached to the disc brake, in particular to the brake caliper or the like, for example with a screw, at the fastening section 75. It can also be attached to an actuator such as a brake cylinder. The suction tube arrangements and the first interfaces of the two brake pads 51, 52 converge in the second interface element 7. It forms the interface to the downstream suction and separation system.

It may be provided that the output connection 73 is designed in the manner of a commercially available hose connection, e.g. in the manner of a plug connection or coupling, etc.

In the illustrated exemplary embodiment, the second interface 7 was designed for a hose clamp attachment. The interface element 7 is preferably attached, in particular screwed, to a brake cylinder interface of the disc brake 1 (FIG. 1). As the remaining suction device is attached directly to the respective brake pad 51, 52, it can also be used as a retrofit kit for brakes already operated in the field.

It is advantageous that the first interface is also provided with a length compensation. In the exemplary embodiment shown, the length compensation is represented by a clearance fit, which is encased in the flexible bellows 5162, 5262.

Ideally, NBR or silicone is used as the material for the bellows 5162, 5262. A slotted bushing can be encapsulated into the connecting ends of the bellows in such a way that the NBR or silicone encasing the slotted bushing is used to seal the connections of the suction tubes 5153, 525 to the bellows 5162, 5262 and the grommet section 74 to the bellows 5162, 5262. The clearance fit of the plug-in connection to the grommet section is advantageously selected to be so large that the vibration amplitude transmitted to the respective brake pad 51, 52 by the vibration load is compensated by the clearance fit.

It should also be noted that the bellows 5162, 5262 should be capable or are able to compensate for the wear path resulting from the brake disc wear, as the pad wear is compensated for by the interface 5116/5117.

The suction tube 525 connected to the reaction-side brake pad 52 can be immersed further into the bellows 5262 assigned to it as the brake pad 52 wears, whereas the suction tube 515 connected to the inside/action-side brake pad 51 moves towards it in the bellows 5162 assigned to it. It is preferably ensured over the entire wear of the brake pads 51, 52 that the respective bellows 5162, 5262, which is drawn together when suction pressure is applied, can rest against the suction tubes 515, 525 without closing the opening to the second interface.

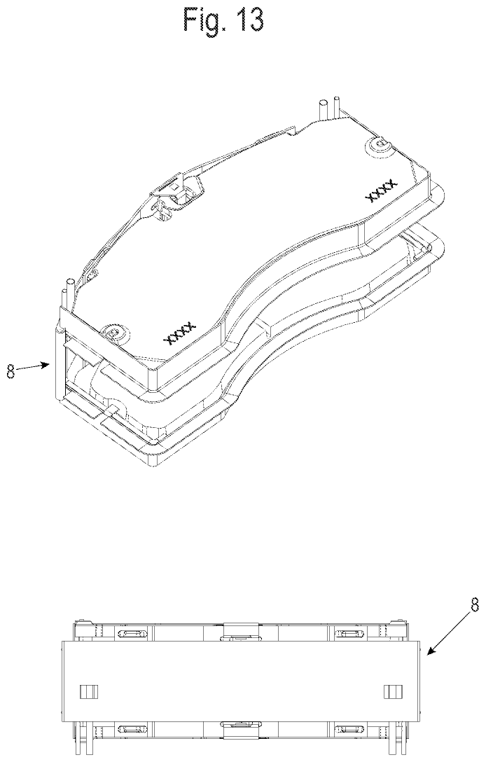

With regard to the geometric design and connection to the overall system, further embodiment variants are described below. The embodiment variant according to FIG. 13 shows suction tubes 515, 525 attached individually to a carrier plate and a cover plate 8. The carrier plate and a cover plate 8 can cover an area between the brake pads towards the opening 6. The advantage of this variant is that the carrier plates also cover the corrosion protection between the brake carrier horn and the brake pad as an additional function.

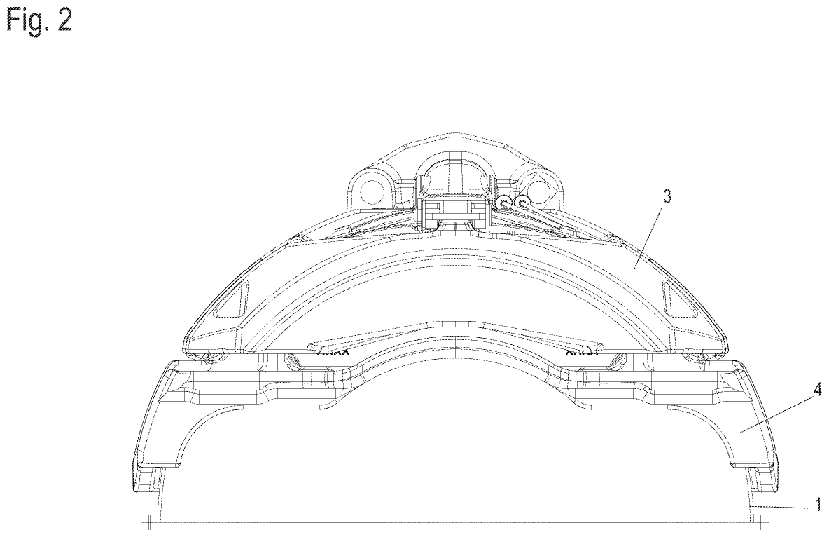

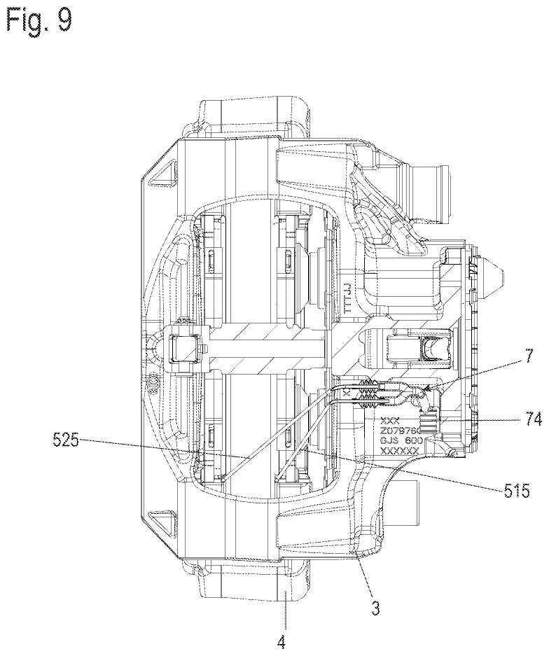

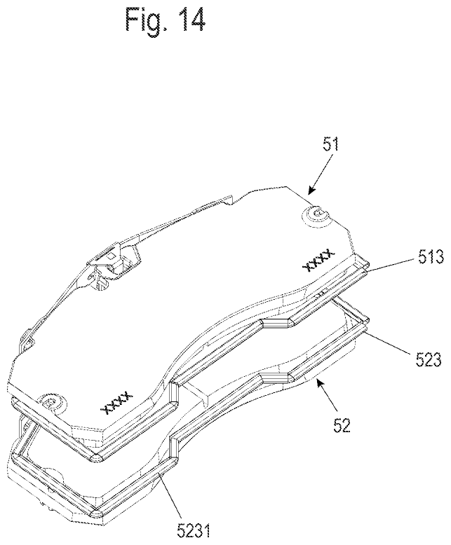

The embodiment variant shown in FIG. 14 shows a further variant and implicitly a manufacturing process of the circumferential suction tubes 513, 523. Here, these are manufactured from drawn or bent profiles which have a thin gap as suction opening 5231 to the contact surface between the brake disc and friction lining 512, 522, through which the brake dust is sucked off. The profile can consist of individual elements that are sealed at the corners by means of plug-in connections. Or, it can be bent and the resulting corner reliefs sealed by cover elements (clipped/welded). As with the variant in FIGS. 1 to 13, both alternative embodiments can compensate for the wear path by means of a guide pin/disc spring connection.

### LIST OF REFERENCE SIGNS

1 Brake disc
2 Friction ring surfaces
3 Brake caliper
4 Brake carrier
51, 52 Brake pads
511, 521 Back plate
512, 522 Friction lining
513,523 Suction tube
514, 524 Y-piece
515, 525 Intermediate tubes
5221 Back plate edge region
5131, 5231 Suction openings
516, 526 Interface element
5161, 5261 Connection section
5162, 5262 Bellows
5116, 5216 Guide pins
5117, 5217 Disc springs
518, 528 Wiper
6 Opening
7 Second interface element
71, 72 Input connections
73 Output connection
74 Grommet section
75 Fastening section
8 Cover plate

1.-20. (canceled)

21. A disc brake, comprising:
a brake caliper which engages over a brake disc in use;
two brake pads arranged in the caliper, which are each provided with a friction lining and a back plate and which are to be pressed with their respective friction lining onto a respective friction ring surface of the brake disc; and
a suction tube arrangement that extracts abrasion material resulting from braking,
wherein the suction tube arrangement comprises one or more suction tubes arranged directly on the two brake pads.

22. The disc brake according to claim 21, wherein
a respective brake pad and the suction tube arranged thereon form a pre-assembled, replaceable unit of the disc brake.

23. The disc brake according to claim 21, wherein
the suction tube arrangement having the suction tubes and the two brake pads form a pre-assembled, replaceable unit of the disc brake.

24. The disc brake according to claim 21, wherein
the suction tubes arranged on the two brake pads have one or more suction openings and are placed in sections or completely circumferentially around the respective friction linings of the two brake pads.

25. The disc brake according to claim 24, wherein
each respective suction tube with the one or more suction openings forms a ring which is closed off by a Y-tube section.

26. The disc brake according to claim 24, wherein
each respective suction tube with the suction openings is movably guided on the respective brake pad.

27. The disc brake according to claim 26, wherein
the respective suction tube with the suction openings is movably guided on the respective brake pad via at least one disc spring.

28. The disc brake according to claim 27, wherein
the respective suction tube terminates with a wear surface of the respective brake pad and rests against the brake disc when the brake pads are pressed on.

29. The disc brake according to claim 28, wherein
a positive fit between a respective guide pin and the disc spring on the two brake pads is designed such that the guide pins are displaced in their axial direction by the respective disc spring, via contact pressure of the brake pads, unidirectionally in a direction of wear and plane-parallel to the wear surface of the brake pads.

30. The disc brake according to claim 21, wherein
the respective suction tube, which is guided around the lining material on the two brake pads, is covered and/or sheathed on the respective brake pad in whole or in sections by a wiper.

31. The disc brake according to claim 21, wherein
the suction tube arrangement has at least one interface for connecting a suction and separation device that is external to the disc brake.

32. The disc brake according to claim 31, wherein
the interface has at least one or more variable-length units and/or elements, which serve to absorb movements of the suction tube arrangement caused by friction lining and brake disc wear.

33. A brake pad set for a disc brake, comprising:
two brake pads, wherein
each brake pad has a friction lining and a back plate, and
one or more suction tubes of a suction tube arrangement are arranged directly on the two brake pads.

34. The brake pad set according to claim 33, wherein
a respective brake pad and the suction tube arranged thereon each form a pre-assembled, replaceable unit of the disc brake, or
the suction tube arrangement and the two brake pads together form an overall pre-assembled, replaceable unit of the disc brake.

35. The brake pad set according to claim 33, wherein
on the two brake pads, a suction tube with suction openings of the suction tube arrangement is placed in each case in sections or completely circumferentially around the friction lining.

36. The brake pad set according to claim 35, wherein
the respective suction tubes with the one or more suction openings form a ring which is closed off by a Y-tube piece.

37. The brake pad set according to claim 33, wherein
the respective suction tube with the suction openings is movably guided on the respective brake pad.

38. The brake pad set according to claim 37, wherein
the respective suction tube with the suction openings is movably guided on the respective brake pad via at least one disc spring.

39. The brake pad set according to claim 33, wherein
the respective suction tube, which is guided on the two brake pads in a circumferential manner around material of the friction lining, is covered and/or sheathed on the respective brake pad in whole or in sections via a wiper device.

40. The brake pad set according to claim 39, wherein
the suction tube arrangement has one or more interfaces having one or more variable-length elements.
